(19) United States
(12) Patent Application Publication
(10) Pub. No.: US 2019/0391916 A1
(43) Pub. Date: Dec. 26, 2019

(54) METHOD FOR MANAGING FLASH MEMORY MODULE AND ASSOCIATED FLASH MEMORY CONTROLLER AND ELECTRONIC DEVICE

(71) Applicant: Silicon Motion Inc., Hsinchu County (TW)

(72) Inventor: Sung-Yen Hsieh, New Taipei City (TW)

(21) Appl. No.: 16/260,011

(22) Filed: Jan. 28, 2019

(30) Foreign Application Priority Data
Jun. 21, 2018 (TW) 107121232

(51) Int. Cl. G06F 12/02; G06F 11/07

(52) U.S. Cl. CPC G06F 12/0253; G06F 12/0292; G06F 12/0246; G06F 11/076

(57) ABSTRACT

The present invention provides a method for managing a flash memory module, wherein the flash memory module includes a plurality of blocks, and the method includes the steps of: building a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation is required, referring to the garbage collection look-up table to select a specific block that has a top priority of the garbage collection operation, and performing the garbage collection operation starting from the specific block.

### BACKGROUND OF THE INVENTION

### 1. Field of the Invention

The present invention is related to flash memory, and more particularly, to a method for managing flash memory module and associated flash memory controller and electronic device.

### 2. Description of the Prior Art

In a conventional flash memory controller, when there are many blocks having a need of being treated with a garbage collection operation in a short time, the flash memory controller may sequentially perform the garbage collection operation on the blocks according to a default priority, for example, performing the garbage collection operation on blocks having a need of wear-leveling first, and so on. However, when performing the garbage collection operation on each block is required, there may be many factors to be considered. In addition to wear-leveling, the factors may comprise read reclaim or read refresh as well. Thus, when the order of performing the garbage collection operation on the blocks is determined simply according to the default priority in the related art, the actual needs of the blocks cannot be properly considered. In general, it is impossible to complete the garbage collection operation of all blocks having such need at once. Thus, the way of the related art may probably make a portion of blocks having lower default priority unable to be treated with the garbage collection operation, and may thereby cause data loss.

### SUMMARY OF THE INVENTION

It is therefore an objective of the present invention to design a method for managing flash memory module, which records a priority of a garbage collection operation of each block through building a garbage collection look-up table, to be a reference for a flash memory controller while performing the garbage collection operation, in order to solve the related art problems.

In an embodiment of the present invention, a method for managing a flash memory module is disclosed, wherein the flash memory module comprises a plurality of blocks, and the method comprises: building a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation of the flash memory module is required, referring to the garbage collection look-up table to select a specific block that has a top priority of the garbage collection operation, and performing the garbage collection operation starting from the specific block.

In another embodiment of the present invention, a flash memory controller is disclosed, wherein the flash memory controller is arranged to access a flash memory module, the flash memory module comprises a plurality of blocks, and the flash memory controller comprises a read only memory that is arranged to store a program code and a microprocessor that is arranged to execute the program code to control access to the flash memory module. In operations of the flash memory controller, the microprocessor builds a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation of the flash memory module is required, the microprocessor refers to the garbage collection look-up table to select a specific block that has a top priority of the garbage collection operation, and performs the garbage collection operation starting from the specific block.

In another embodiment of the present invention, an electronic device is disclosed, which comprises a flash memory module that comprises a plurality of blocks and a flash memory controller that is arranged to access the flash memory module. In operations of the electronic device, the flash memory controller builds a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation is required, the flash memory controller refers to the garbage collection look-up table to select a specific block that has a top priority of the garbage collection operation, and performs the garbage collection operation starting from the specific block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to an embodiment of the present invention.

FIG. 2 is a diagram illustrating a wear-leveling requirement data table according to an embodiment of the present invention.

FIG. 3 is a diagram illustrating a read reclaim requirement data table according to an embodiment of the present invention.

FIG. 4 is a diagram illustrating a read refresh requirement data table according to an embodiment of the present invention.

FIG. 5 is a diagram illustrating a garbage collection look-up table according to an embodiment of the present invention.

FIG. 6 is a flowchart illustrating the method for managing a flash memory module according to an embodiment of the present invention.

### DETAILED DESCRIPTION

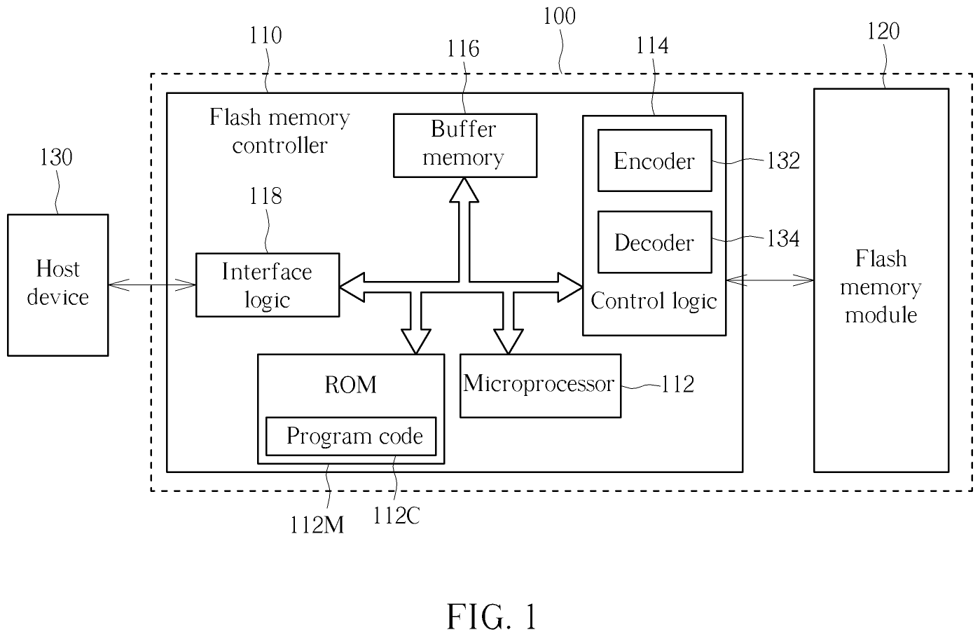

FIG. 1 is a diagram illustrating a memory device 100 according to an embodiment of the present invention. The memory device 100 comprises a flash memory module 120 and a flash memory controller 110, and the flash memory controller 110 is arranged to access the flash memory module 120. According to this embodiment, the flash memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control access to the flash memory module 120. The control logic 114 comprises an encoder 132 and a decoder 134, where the encoder 132 is arranged to encode data that is written into the flash memory module 120 to generate corresponding check code (which may be referred to as error correction code (ECC)), and the decoder 134 is arranged to decode data that is read from the flash memory module 120.

Typically, the flash memory module 120 comprises a plurality of flash memory chips and each flash memory chip comprises a plurality of blocks, and the flash memory controller 110 performs data erasing operations on the flash memory module 120 in unit of block. In addition, a block may record a specific number of data pages, where the flash memory controller 110 performs data writing operations on the flash memory module 120 in unit of data page. In this embodiment, the flash memory controller 120 is a 3D NAND-type flash memory module.

In practice, the flash memory controller 110 executing the program code 112C through the microprocessor 112 may utilize internal components within the flash memory controller 110 to perform various control operations, for example, utilizing the control logic 114 to control access operations of the flash memory module 120 (more particularly, the access operations to at least one block or at least one data page), utilizing the buffer memory 116 to perform required buffer processing, and utilizing the interface logic 118 to communicate with a host device 130. The buffer memory 116 is implemented by a random access memory (RAM). For example, the buffer memory 116 may be a static RAM (SRAM), but the present invention is not limited thereto.

In an embodiment, the memory device 100 may be a portable memory device (e.g. a memory card conforming to SD/MMC, CF, MS or XD specification), and the host device 130 is an electronic device that is capable of connecting with memory devices, such as any of a mobile phone, a laptop computer, a desktop computer, and so on. In another embodiment, the memory device 100 may be a solid-state drive (SSD) or an embedded storage device conforming to universal flash storage (UFS) or embedded multi media card (EMMC) specifications, to be installed in an electronic device, such as the mobile phone, the laptop computer, or the desktop computer, where the host device 130 may be a processor of the electronic device.

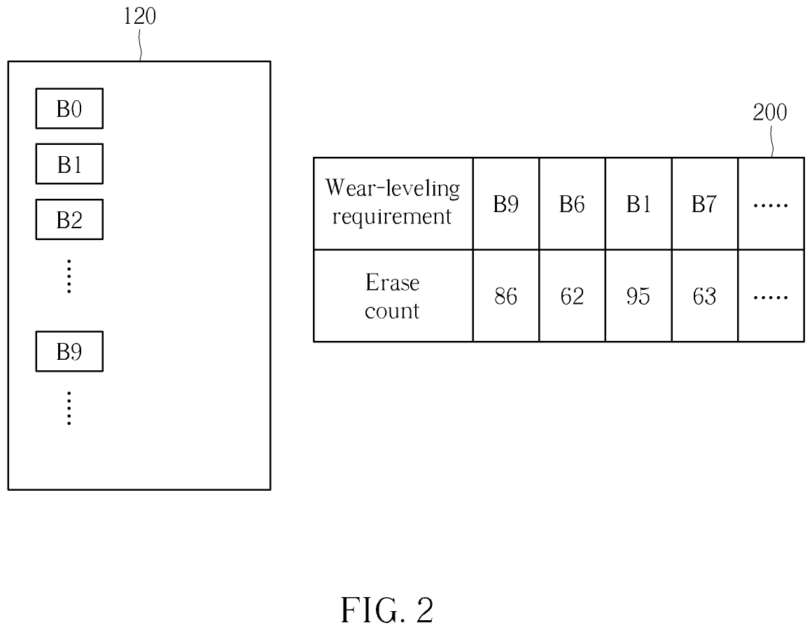

In a process of the flash memory controller 110 reading the flash memory module 120, the flash memory controller 110 may build or refresh a wear-leveling requirement data table, a read reclaim requirement data table and a read refresh requirement data table. FIG. 2 is a diagram illustrating a wear-leveling requirement data table 200 according to an embodiment of the present invention. Referring to FIG. 2, assuming that there are a plurality of blocks B1, B2, B3 . . . in the flash memory module 120, the wear-leveling requirement data table 200 may record one or more blocks (within the plurality of blocks), each having an erase count (e.g. a number of times that a block has been erased) greater than a first threshold, and may record erase counts thereof, where the erase count indicates a total erase count that is counted starting from a time point when the flash memory controller 110 starts operating after it is connected with the flash memory module 120. For example, assuming that the first threshold is 60, as erase counts of the blocks B9, B6, B1 and B7 are 86, 62, 95 and 63, respectively, which are greater than 60, the blocks B9, B6, B1, B7 and the erase counts thereof may be recorded in the wear-leveling requirement data table 200. As erase counts of the rest of the blocks are not greater than 60 times, or the rest of the blocks belong to blank blocks, the rest of the blocks are not recorded in the wear-leveling requirement data table 200.

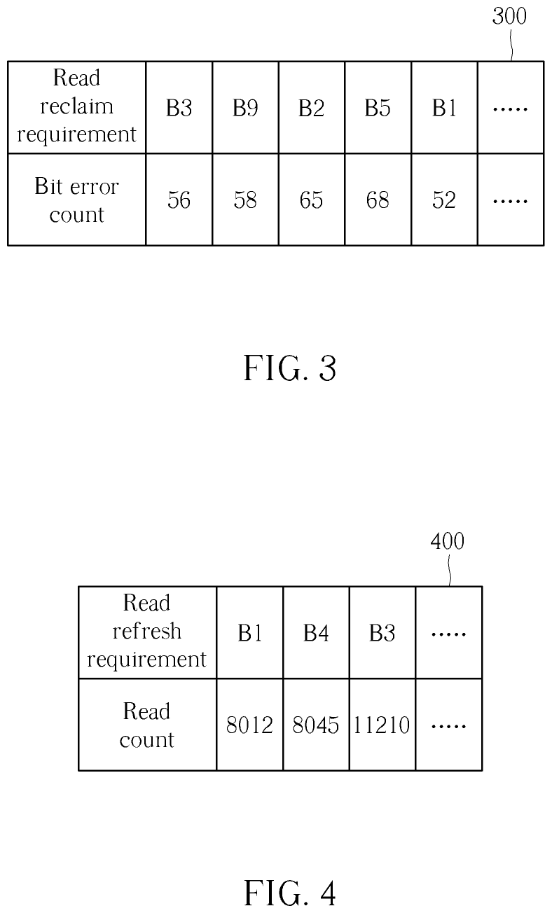

FIG. 3 is a diagram illustrating a read reclaim requirement data table 300 according to an embodiment of the present invention. Referring to FIG. 3, assuming that there are the plurality of blocks B1, B2, B3 . . . in the flash memory module 120 as shown in FIG. 2, the read reclaim requirement data table 300 may record one or more blocks (within the plurality of blocks), each having a bit error count greater than a second threshold, and may record error bit counts thereof. For example, assuming that the second threshold is 50, as bit error counts of the blocks B3, B9, B2, B5 and B1 are 56, 58, 65, 68 and 52, respectively, which are greater than 50, the blocks B3, B9, B2, B5, B1 and the bit error counts thereof may be recorded in the read reclaim requirement data table 300. In this embodiment, the read claim requirement data table 300 is a queue, and the aforementioned bit error count is obtained by decoding after the flash memory controller 110 reads a sector or a chunk of any data page within a block. That is, during reading a block, when detecting that a bit error count of a decoded sector or chunk is greater than 50, the flash memory controller 110 may add the block into the read reclaim requirement data table 300.

FIG. 4 is a diagram illustrating a read refresh requirement data table 400 according to an embodiment of the present invention. Referring to FIG. 4, assuming that there are the plurality of blocks B1, B2, B3 . . . in the flash memory module 120 as shown in FIG. 2, the read refresh requirement data table 400 may record one or more blocks (within the plurality of blocks), each having a read count (e.g. a number of times that a block has been read) greater than a third threshold, and may record read counts thereof. For example, assuming that the third threshold is 8000, as read counts of the blocks B1, B4 and B3 are 8012, 8045 and 11210, respectively, which are greater than 8000, the blocks B1, B4, B3 and the read counts thereof may be recorded in the read refresh requirement data table 400. In this embodiment, only queue part is illustrated in the read refresh requirement data table 400, and in practice, the read refresh requirement data table 400 may also comprise a record table that records the read count of each block. When the flash memory controller 110 sends a read command to ask for reading data of a block within the blocks, the read count of the block may increase with an increment of one, and when contents or data of the block are erased and re-written data therein, the read count recorded in the record table may be reset for restarting counting.

In this embodiment, the aforementioned wear-leveling requirement data table 200, read reclaim requirement data table 300 and read refresh requirement data table 400 are kept being refreshed in the fresh memory module 120 during a process of the flash memory controller 110 accessing the flash memory module 120, and may be temporarily stored in the buffer memory 116.

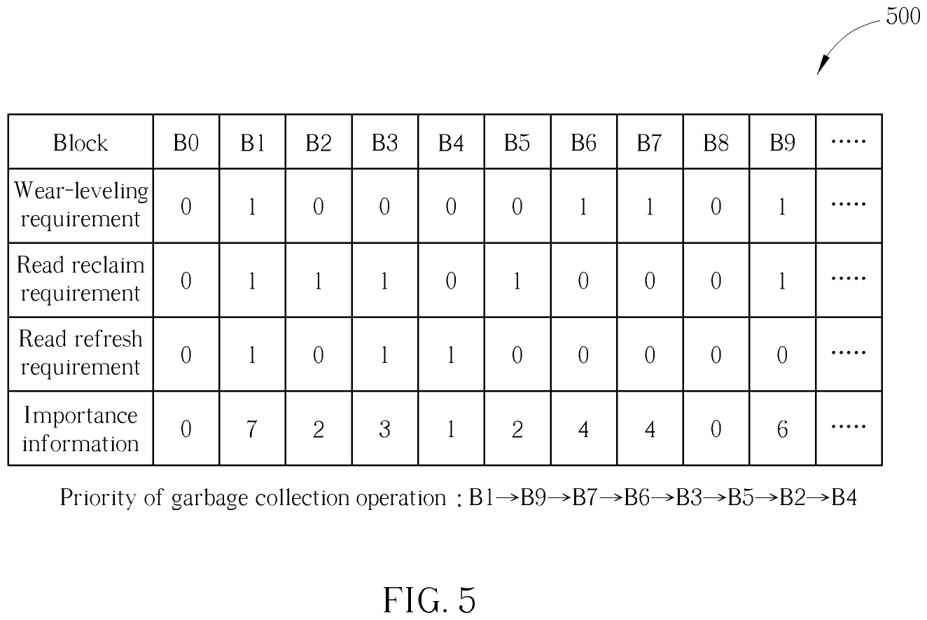

In this embodiment, the flash memory controller 110 may build a garbage collection look-up table according to the contents or data of the aforementioned wear-leveling requirement data table 200, read reclaim requirement data table 300 and read refresh requirement data table 400, where the garbage collection look-up table records a plurality of sets of importance information respectively corresponding to the plurality of blocks, and each set of importance information is used to represent a priority of performing a garbage collection operation on a corresponding block. Please refer to FIG. 5, which is a diagram illustrating a garbage collection look-up table 500 according to an embodiment of the present invention. As shown in FIG. 5, the garbage collection look-up table 500 may record a set of importance information of each of the blocks B1, B2, B3 . . . , where the set of importance information is obtained by calculating information of the aforementioned each block in the wear-leveling requirement data table 200, the read reclaim requirement data table 300 and the read refresh requirement data table 400. More particularly, in this embodiment, it is assumed that the importance of wear-leveling requirement is greater than that of read reclaim requirement and the importance of read reclaim requirement is greater than that of read refresh requirement, and thus, weightings of the wear-leveling requirement, the read reclaim requirement and the read refresh requirement are assumed to be 4, 2 and 1, respectively. Thus, taking the block B1 as an example, since the block B1 is recorded in all of the wear-leveling requirement data table 200, the read reclaim requirement data table 300 and the read refresh requirement data table 400 (i.e. the block B1 has the wear-leveling requirement, the read reclaim requirement and the read refresh requirement, concurrently), a set of importance information of the block B1 may be calculated as follows: 4*1+2*1+1*1=7. In addition, taking the block B3 as an example, since the block B3 is only recorded in the read reclaim requirement data table 300 and the read refresh requirement data table 400 (i.e. the block B3 only has the read reclaim requirement and the read refresh requirement), a set of importance information of the block B3 may be calculated as follows: 4*0+2*1+1*1=3. As mentioned above, since the set of importance information of the aforementioned each block is calculated by referring to each of the wear-leveling requirement, the read reclaim requirement and the read refresh requirement, the priority of the garbage collection of the aforementioned each block can be indeed reflected. That is, as shown in FIG. 5, a greater value of the set of importance information indicates a higher priority of the garbage collection operation.

In this embodiment, when respective sets of importance information of two blocks are the same, for example, the sets of importance information of B6 and B7 are both “4”, re-referring to the contents or data of the wear-leveling requirement data table 200, the read reclaim requirement data table 300 and/or the read refresh requirement data table 400 to determine priorities thereof is needed. For example, since the wear-leveling requirement data table 200 records that the erase count of the block B7 is greater than the erase count of the block B6, the flash memory controller 110 may determine that the priority of the garbage collection operation of the block B7 is greater than the priority of the garbage collection operation of the block B6.

In this embodiment, when the garbage collection operation of the flash memory module 120 is required, the flash memory controller 110 may sequentially perform the garbage collection operation on the blocks B1, B9, B7, B6, B3, B5, B2 and B4 according to the sets of importance information recorded by the garbage collection look-up table 500. That is, the flash memory controller 110 may move valid data within the blocks B1, B9, B7, B6, B3, B5, B2 and B4 into other blocks such as blank blocks, and erase a block (e.g. any of the blocks B1, B9, B7, B6, B3, B5, B2 and B4) or label this block as invalid after all valid data within this block have been moved.

As mentioned above, since the set of importance information of the aforementioned each block is calculated by referring to each of the wear-leveling requirement, the read reclaim requirement and the read refresh requirement, a block having greater importance information (e.g. a greater value of importance information) usually has two or more requirements, concurrently. Thus, preferentially performing the garbage collection operation on the block having greater importance information can complete two or more requirements, concurrently, where the performance of the flash memory controller 110 can be improved. Taking FIG. 5 as an example, since the block B1 having the greatest importance information (e.g. the greater value of importance information) has the wear-leveling requirement, the read reclaim requirement and the read refresh requirement, concurrently, preferentially performing the garbage collection operation on the block B1 can complete these three requirements, concurrently, and space of the read reclaim requirement data table 300 and the read refresh requirement data table 400 can be quickly released to prevent the condition of queue overflow.

In another embodiment of the present invention, the garbage collection look-up table 500 may just be built according to two of the wear-leveling requirement data table 200, the read reclaim requirement data table 300 and the read refresh requirement data table 400. That is, the garbage collection look-up table 500 may just reflect the wear-leveling requirement and the read reclaim requirement of each block, or just reflect the wear-leveling requirement and the read refresh requirement of each block, or just reflect the read reclaim requirement and the read refresh requirement of each block. These alterations on design should be included in the scope of the present invention.

It should be noted that, the garbage collection look-up table 500 shown in FIG. 5 is an example for descriptive purpose only, and is not meant to be a limitation of the present invention. In other embodiments, the garbage collection look-up table 500 may just record a serial number of the aforementioned each block and the value of importance information of the aforementioned each block, and the value of importance information may be recorded in different ways. As long as the contents or data recorded by the garbage collection look-up table 500 may reflect the priority of performing the garbage collection operation on the aforementioned each block, the way of recording may be presented in different ways.

In an embodiment of the present invention, the aforementioned garbage collection operation is performed in a process of a background scan being performed on the flash memory module 120. That is, the flash memory controller 110 may perform the garbage collection operation, periodically, or determine whether to begin the garbage collection according to a schedule. When the flash memory controller 110 determines to perform the garbage collection operation, the flash memory controller 110 may refer to the garbage collection look-up table 500 shown in FIG. 5 to determine which block(s) should be selected for preferentially performing the garbage collection operation. It should be noted that, the garbage collection operation may be triggered by other mechanisms, for example, the garbage collection operation may be triggered when a number of available blocks (blank blocks) within the flash memory module 120 is not enough. Since the garbage collection operation in this embodiment is performed during the background scan, the priorities of performing the garbage collection operation on the blocks may only be determined only by referring the garbage collection look-up table 500 without considering other factors such as shortage of available blocks.

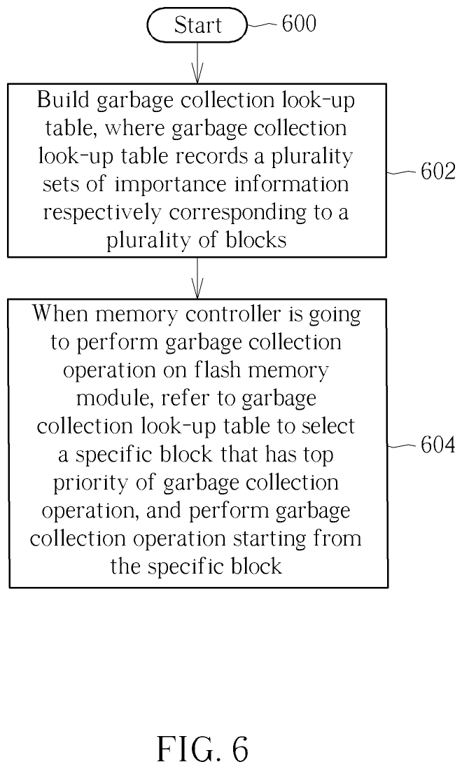

FIG. 6 is a flowchart illustrating the method for managing a flash memory module according to an embodiment of the present invention. Referring to descriptions disclosed in FIGS. 1-5, a flow of FIG. 6 may be described as follows:

Step 600: The flow start.

Step 602: Build garbage collection look-up table, where the garbage collection look-up table records a plurality sets of importance information respectively corresponding to a plurality of blocks.

Step 604: When a memory controller is going to perform a garbage collection operation on the flash memory module, the memory controller refers to the garbage collection look-up table to select a specific block that has a top priority of the garbage collection operation, and performs the garbage collection operation starting from the specific block.

Briefly summarized, regarding the method for managing a flash memory module and associated flash memory controller, through building a garbage collection look-up table, a priority of a garbage collection operation for each block is recorded as a reference for the flash memory controller performing the garbage collection operation. Since the garbage collection look-up table may be dynamically refreshed during the process of the flash memory controller accessing the flash memory module, the garbage collection look-up table can indeed reflect correct priorities to make the garbage collection operation be performed more efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a flash memory module, wherein the flash memory module comprises a plurality of blocks, and the method comprises:
building a garbage collection look-up table, wherein the garbage collection look-up table records a plurality of sets of importance information respectively corresponding to the plurality of blocks, and each set of importance information is used to represent a priority of performing a garbage collection operation on a corresponding block; and
when performing the garbage collection operation of the flash memory module is required, referring to the garbage collection look-up table to select a specific block that has a top priority of the garbage collection operation, and performing the garbage collection operation starting from the specific block.

2. The method of claim 1, wherein the step of building the garbage collection look-up table comprises:
referring to at least two of a wear-leveling requirement data table, a read reclaim requirement data table and a read refresh requirement data table, to build the garbage collection look-up table.

3. The method of claim 2, wherein the step of building the garbage collection look-up table comprises:
referring to each of the wear-leveling requirement data table, the read reclaim requirement data table and the read refresh requirement data table, to build the garbage collection look-up table.

4. The method of claim 3, wherein a set of importance information of each block within the garbage collection look-up table is determined according to whether said each block appears in one or more of the wear-leveling requirement data table, the read reclaim requirement data table and the read refresh requirement data table.

5. The method of claim 4, wherein the wear-leveling requirement data table, the read reclaim requirement data table and the read refresh requirement data table have corresponding weightings, respectively, and the set of importance information of said each block within the garbage collection look-up table is determined according to whether said each block appears in one or more of the wear-leveling requirement data table, the read reclaim requirement data table and the read refresh requirement data table and according to the corresponding weightings.

6. The method of claim 5, wherein a weighting of the wear-leveling requirement data table is greater than weightings of the read reclaim requirement data table and the read refresh requirement data table.

7. The method of claim 3, wherein the wear-leveling requirement data table records one or more blocks, each having an erase count greater than a first threshold, and records erase counts thereof; the read reclaim requirement data table records one or more blocks, each having a bit error count greater than a second threshold, and records bit error counts thereof; and the read refresh requirement data table records one or more blocks, each having a read count greater than a third threshold, and records read counts thereof.

8. The method of claim 7, wherein the step of referring to the garbage collection look-up table to select the specific block that has the top priority of the garbage collection operation comprises:
when two or more blocks have same importance information, referring to the erase counts of the one or more blocks recorded by the wear-leveling requirement data table, or referring to the bit error counts of the one or more blocks recorded by the read reclaim requirement data table, or referring to the read counts of the one or more blocks recorded by the read refresh requirement data table, to select the specific block that has the top priority of the garbage collection operation.

9. The method of claim 1, wherein the step of referring to the garbage collection look-up table to select the specific block that has the top priority of the garbage collection operation and the step of performing the garbage collection operation starting from the specific block are performed in a process of a flash memory controller performing a background scan on the flash memory module.

10. A flash memory controller, wherein the flash memory controller is arranged to access a flash memory module, the flash memory module comprises a plurality of blocks, and the flash memory controller comprises:
a read only memory, arranged to store a program code; and
a microprocessor, arranged to execute the program code to control access to the flash memory module;
wherein the microprocessor builds a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation of the flash memory module is required, the microprocessor refers to the garbage collection look-up table to select a specific block that has a top priority of the garbage collection operation, and performs the garbage collection operation starting from the specific block.

11. The flash memory controller of claim 10, wherein the microprocessor refers to at least two of a wear-leveling requirement data table, a read reclaim requirement data table and a read refresh requirement data table, to build the garbage collection look-up table.

12. The flash memory controller of claim 11, wherein the microprocessor refers to each of the wear-leveling requirement data table, the read reclaim requirement data table and the read refresh requirement data table, to build the garbage collection look-up table.

13. The flash memory controller of claim 12, wherein a set of importance information of each block within the garbage collection look-up table is determined according to whether said each block appears in one or more of the wear-leveling requirement data table, the read reclaim requirement data table and the read refresh requirement data table.

14. The flash memory controller of claim 13, wherein the wear-leveling requirement data table, the read reclaim requirement data table and the read refresh requirement data table have corresponding weightings, respectively, and the set of importance information of said each block within the garbage collection look-up table is determined according to whether said each block appears in one or more of the wear-leveling requirement data table, the read reclaim requirement data table and the read refresh requirement data table and according to the corresponding weightings.

15. The flash memory controller of claim 14, wherein a weighting of the wear-leveling requirement data table is greater than weightings of the read reclaim requirement data table and the read refresh requirement data table.

16. The flash memory controller of claim 12, wherein the wear-leveling requirement data table records one or more blocks, each having an erase count greater than a first threshold, and records erase counts thereof; the read reclaim requirement data table records one or more blocks, each having a bit error count greater than a second threshold, and records bit error counts thereof; and the read refresh requirement data table records one or more blocks, each having a read count greater than a third threshold, and records read counts thereof.

17. The flash memory controller of claim 16, wherein when two or more blocks have same importance information, the microprocessor refers to the erase counts of the one or more blocks recorded by the wear-leveling requirement data table, or refers to the bit error counts of the one or more blocks recorded by the read reclaim requirement data table, or refers to the read counts of the one or more blocks recorded by the read refresh requirement data table, to select the specific block that has the top priority of the garbage collection operation.

18. The flash memory controller of claim 10, wherein in a process of performing a background scan on the flash memory module, the microprocessor refers to the garbage collection look-up table to select the specific block that has the top priority of the garbage collection operation, and performs the garbage collection operation starting from the specific block.

19. An electronic device, comprising:
a flash memory module, comprising a plurality of blocks; and
a flash memory controller, arranged to access the flash memory module;
wherein the flash memory controller builds a garbage collection look-up table, wherein the garbage collection look-up table records a plurality of sets of importance information respectively corresponding to the plurality of blocks, and each set of importance information is used to represent a priority of performing a garbage collection operation on a corresponding block; and when performing the garbage collection operation is required, the flash memory controller refers to the garbage collection look-up table to select a specific block that has a top priority of the garbage collection operation, and performs the garbage collection operation starting from the specific block.

20. The electronic device of claim 19, wherein the flash memory controller refers to each of the wear-leveling requirement data table, the read reclaim requirement data table and the read refresh requirement data table, to build the garbage collection look-up table.
